(19) United States
(12) Patent Application Publication
(10) Pub. No.: US 2013/0337790 A1
(43) Pub. Date: Dec. 19, 2013

(54) METHOD AND APPARATUS FOR CONTROLLING AN OUTGOING CALL

(71) Applicant: Choong Rouk Oh, Gunpo (KR)

(72) Inventor: Choong Rouk Oh, Gunpo (KR)

(73) Assignee: INTELLECTUAL DISCOVERY, LTD., Seoul (KR)

(21) Appl. No.: 13/997,614

(22) PCT Filed: Dec. 21, 2011
(86) PCT No.: PCT/KR2011/009960

§ 371 Date: Aug. 26, 2013

(30) Foreign Application Priority Data
Dec. 24, 2010 (KR) 10-2010-0134159

(51) Int. Cl. H04W 4/16

(52) U.S. Cl. CPC H04W 4/16
USPC 455/414.1

(57) ABSTRACT

Disclosed is a method for controlling an outgoing call. The method for controlling an outgoing call in a mobile phone according to one aspect of the present invention comprises: a step of analyzing an audio signal input from an external source through a microphone for a predetermined time in accordance with preset criteria when an outgoing call gets connected; and a step of determining whether the outgoing call is normal or abnormal based on the result of the audio signal analysis. The method for controlling an outgoing call according to the present invention may disconnect a call in a short time when an outgoing call is unintentionally or erroneously conducted, to thereby prevent a wasted call charge, and may deliver a message indicating such an erroneous call to a caller so that the caller may recognize the erroneous call, to thereby minimize inconvenience of the caller.

### CROSS-REFERENCE TO RELATED APPLICATIONS

This application claims priority to and the benefit of Korean Patent Application No. 10-2010-0134159 filed in the Korean Intellectual Property Office on Dec. 24, 2010, the entire contents of which are incorporated herein by reference.

### BACKGROUND OF THE INVENTION

The present invention relates to controlling an outgoing call. More particularly, the present invention relates to a method and a mobile phone for controlling a wrong outgoing call that a user makes by mistake.

Recently, with advances in mobile communication technology, almost all people own mobile phones capable of being carried with them. Especially, recently, smartphones, which can execute various application programs installed therein in addition to a telephone function, have entered into use.

Such a mobile phone that many people use is usually kept in the pocket of a user due to its small size and, thus, buttons of the mobile phone may be unintentionally pressed, thereby frequently placing an unintended outgoing call. Moreover, even in the case that children touch the mobile phone, an unintended outgoing call may be frequency placed.

An abnormal outgoing call as described above results in waste of communication costs from the viewpoint of a calling party and in waste of time such as reception of a wrong call of the calling party from the viewpoint of a called part.

### SUMMARY OF THE INVENTION

Accordingly, an object of the present invention devised to solve the above-described problem lies in providing a method and apparatus for controlling an outgoing call upon a connection of the outgoing call according to whether or not the outgoing call is normal by analyzing an audio signal input from the exterior.

Other objects of the present invention will become apparent from exemplary embodiments described herein below.

According to one aspect of the present invention, a method for controlling an outgoing call in a mobile phone, comprises analyzing an input audio signal according to a preset reference upon a connection of the outgoing call, wherein the input audio signal is inputted from an external source through a microphone for a predetermined time, and determining whether the outgoing call is a normal outgoing call or an abnormal outgoing call according to a result of the analyzing.

The analyzing may include determining whether at least one prestored reference audio signal includes an audio signal which is the same as the input audio signal.

The analyzing may include determining whether the input audio signal includes human voice having a preset strength or when the input audio signal includes human voice determining whether text obtained by analyzing the voice includes a preset phrase.

When the outgoing call is determined to be the abnormal outgoing call or a preset text message may e transmitted to a called party.

A preset voice message may be transmitted to a called party before the connection of the outgoing call is released.

When the outgoing call is determined to be the abnormal outgoing call, the method may further comprise performing a vibration function or a preset sound output function.

According to another aspect of the present invention, a method for controlling an outgoing call in a mobile phone comprises determining whether at least one prestored reference audio signal includes an audio signal which is the same as an input audio signal upon a connection of the outgoing call, wherein the input audio signal is inputted from an external source through a microphone for a predetermined time, when the reference audio signal includes the audio signal processing the outgoing call as a normal outgoing call, and when the reference audio signal does not include the audio signal determining whether the outgoing call is the normal outgoing call or an abnormal outgoing call by analyzing the input audio signal, and when the outgoing call is determined to be the normal outgoing call storing the input audio signal as a new reference audio signal, and when the outgoing call is determined to be the abnormal outgoing call controlling the outgoing call according to the predetermined scheme.

According to still another aspect of the present invention, provided herein is a mobile communication device comprising a communication module connecting a telephone call, a sound input module receiving a sound from an external source, and a controller configured to when a outgoing call is connected analyze an input audio signal according to a preset reference, wherein the input audio signal is inputted from an external source through the sound input module for a preset time, and determining whether the outgoing call is a normal outgoing call or an abnormal outgoing call according to a result of the analyzing.

The controller may determine whether the outgoing call is the normal outgoing call or the abnormal outgoing call by determining whether the input audio signal includes human voice having a preset strength.

According to the present invention, waste of call costs can be prevented by releasing a call connection in a short time even if an unintended outgoing call is made.

In addition, according to the present invention, inconvenience of a called party can be minimized during a wrong call connection by transmitting an announcement message to the called party to enable the called party to recognize a wrong call.

### BRIEF DESCRIPTION OF THE DRAWINGS

FIG. 1 is a flowchart illustrating an outgoing call control processing procedure in a mobile phone according to an embodiment of the present invention.

FIG. 2 is a flowchart illustrating a procedure of determining a normal or abnormal outgoing call using reference data and generating or updating the reference data according to another embodiment of the present invention.

FIG. 3 is a block diagram illustrating configuration of a mobile phone performing outgoing call control according to an embodiment of the present invention.

### DETAILED DESCRIPTION OF EMBODIMENTS

Various modifications may be made to the present invention and various embodiments of the present invention may be implemented. Specific embodiments are illustrated in the drawings and a detailed description thereof will now be given. However, it is to be understood that the present invention is not limited to the specific embodiments and includes all alternations, equivalents, and substitutions within the spirit and technical scope of the present invention.

Reference will now be made in detail to the exemplary embodiments of the present invention, examples of which are illustrated in the accompanying drawings. In the drawings, the same or similar elements are denoted by the same reference numerals and a repeated description thereof will be omitted.

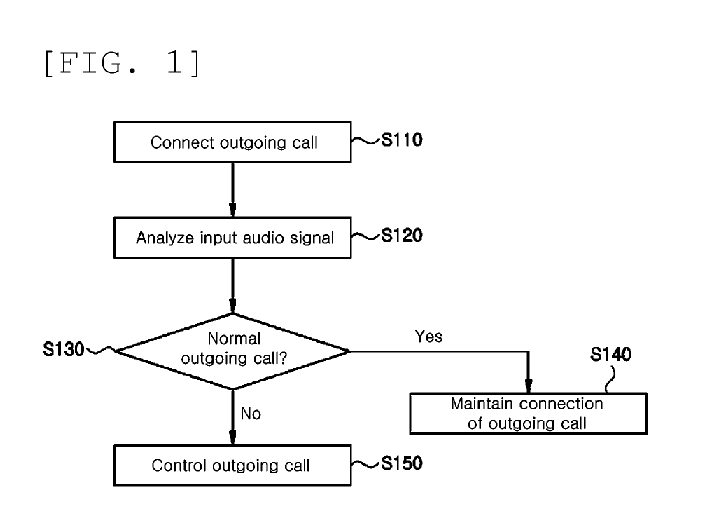

FIG. 1 is a flowchart illustrating an outgoing call control processing procedure in a mobile phone according to an embodiment of the present invention.

Referring to FIG. 1, when an outgoing call is connected (S110), the mobile phone analyzes an input audio signal, which is inputted through a sound source means (e.g. a microphone) from the exterior for a preset time (e.g. one to three seconds), according to a preset reference (S120).

Analysis of the input audio signal according to an embodiment invention may be performed by analyzing whether human voice is included in the input audio signal and/or whether voice of the input audio signal includes a preset phrase.

Generally, upon responding to a call made by a calling party, a called party says “Hello” or “Hi”. Accordingly, if an outgoing call is attempted and the called party answers the call so that the outgoing call is connected, the mobile phone analyzes the input audio signal input through the microphone to determine whether the calling party speaks and/or whether the calling party says the preset phrase.

In addition, even if an outgoing call unintended by the calling party is connected, since the case in which human voice is input through the microphone may occur, the mobile phone may measure strength of a voice signal and recognize the voice signal as a normal outgoing call only when the strength of the voice signal is above a preset strength. In other words, although voice may be input even in an unintended outgoing call, a low voice would be input because the mouth of the calling party is not near to the microphone in the above case. Therefore, it may be determined whether a call is a normal outgoing call by measuring strength of input voice.

That is, the mobile phone may determine whether an input audio signal includes a human voice signal and also measure strength of the voice signal. In addition, the mobile phone may analyze the voice signal to determine whether the voice signal matches a preset specific phrase.

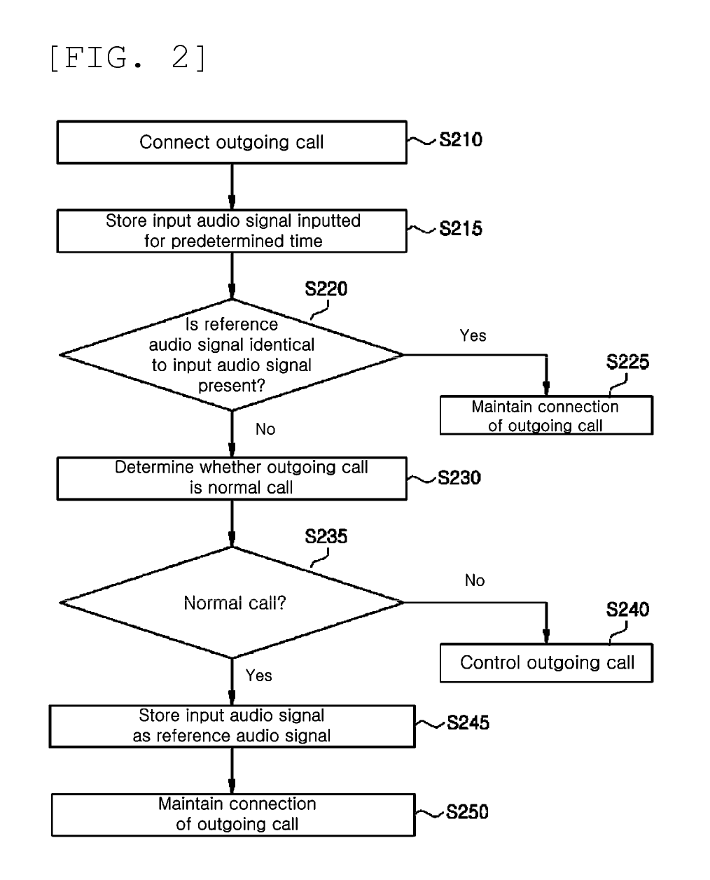

According to another embodiment of the above example, analysis of the input audio signal may be performed by determining whether an input voice signal is a preset audio signal. In other words, it is determined whether the input voice signal is voice which is frequently spoken after an outgoing call of a user is connected. This is to compare waveforms and tone colors of the input voice signal with those of a prestored reference audio (refer to FIG. 2), unlike the above example of recognizing the preset phrase by analyzing the voice signal. As an example for convenience of understanding, assuming that the user frequently says “Hello” immediately after an outgoing call is connected, an input audio signal input when the user says “Hello” is prestored in the mobile phone as a reference audio signal. Thereafter, if an outgoing call is connected, the mobile phone analyzes an input audio signal by comparing the input audio signal with the prestored reference audio signal.

In addition, to store reference data such as the above reference audio signal, the mobile phone usually stores, as the reference data, an input audio signal input thereto spoken by the user for a predetermined time (e.g. three seconds) immediately after an outgoing call is connected. This will be described later in detail.

Referring back to FIG. 1, the mobile phone determines whether a currently connected call is a normal outgoing call or not according to the analyzed results of the input audio signal (S130).

That is, the mobile phone determines whether an outgoing call is a normal call or not, using at least one of the analyzed results as to whether human voice is included in the input audio signal, whether strength of human voice is above a preset strength in the case in which the human voice is included in the input audio signal, whether human voice includes a preset phrase through voice recognition in the case in which the human voice is included in the input audio signal, and whether the same reference audio signal as the input audio signal is present through comparison of the input audio signal with the prestored reference data.

For example, when the input audio signal includes human voice, a corresponding call may be determined to be a normal outgoing call. Alternatively, strength of the voice may be measured and the call may be determined to be a normal outgoing call only when the measured strength is above a preset strength. As another example, the call may be determined to be a normal outgoing call only when text obtained as a result of analyzing the voice according to the input audio signal corresponds to a preset phrase. Currently, various websites provide services for performing keyword search through voice and speech-to-text (STT) technology for converting voice into text is provided. Therefore, conversion of an audio signal into text is apparent to those skilled in the art and a detailed description thereof will be omitted. In addition, if an audio signal, which is the same as an input audio signal or is similar to the input audio signal by a prescribed level or more, is stored as reference data as a comparison result of the input audio signal with prestored reference data, a corresponding call may be determined to be a normal outgoing call. This will be described in detail with reference to FIG. 2.

The mobile phone, which has recognized whether the outgoing call is a normal call or not, maintains connection of the outgoing call in case of the normal outgoing call (S140) and performs a preset outgoing call control operation in case of the abnormal outgoing call (S150).

The outgoing call control operation according to an embodiment of the present invention involves immediately releasing connection of the outgoing call. Namely if an outgoing call is recognized as an abnormal outgoing call, the mobile phone releases connection of the call by immediately disconnecting the call.

According to another embodiment, the mobile phone releases connection of the outgoing call after outputting a voice message through the connected outgoing call to a called party. For example, the mobile phone may transmit a voice message “Unintended call detected. Sorry. Closing connection” to the called party.

According to still another embodiment, if a connected outgoing call is recognized as an abnormal outgoing call, the mobile phone may immediately release connection of the call and transmit a preset text message (a message which is equal or similar to contents of the above voice message) to the called party through a mobile communication network service such as a short message service (SMS) or a multimedia message service (MMS).

Here, the voice message or text message may be directly recorded or composed by a user. That is, the user may previously record the voice message using a recording function or compose and store the text message using a text composition function.

According to a further embodiment, if a connected outgoing call is recognized as an abnormal outgoing call, the mobile phone may perform a vibration function or generate a preset sound source (bell sound) so that the user may recognize that an outgoing call is connected. Accordingly, the user can recognize that the outgoing call has been connected through vibration or bell sound, as in reception of a phone call.

Hereinafter, a method for determining whether an outgoing call is a normal outgoing call using the above reference data and generating or updating the reference data will be described.

FIG. 2 is a flowchart illustrating a procedure of determining a normal or abnormal outgoing call using reference data and generating or updating the reference data according to another embodiment of the present invention.

Referring to FIG. 2, if an outgoing call is connected (S210), the mobile phone temporarily stores an input audio signal input for a prescribed time (e.g. three seconds) (S215) and compares one or more reference audio signals stored as reference data with the input audio signal to determine whether an audio signal which is the same as input audio signal is present in the reference audio signals (S220).

As described above, it is determined whether an audio signal (reference audio) identical to an input audio signal after an outgoing call is connected is present as reference data. Here, the audio signal identical to the input audio signal includes the concept of the audio signal similar to the input audio signal by a prescribed level (e.g. 80%) or more, rather than the audio signal which is completely the same as the input audio signal. A method for determining whether the two audio signals are the same may be performed in various ways such as comparison of waveforms of the two audio signals and comparison of tones of the two audio signals. This will be apparent to those skilled in the art and, therefore, a detailed description will be omitted.

That is, in step S220, one or more reference audio signals prestored as reference data are compared with an input audio signal input according to a currently connected outgoing call, thereby determining whether there is a matching signal.

In this case, it is apparent that, at first, the reference audio signal may not be present at all and, later, the reference audio may be newly configured. This will be understood from the following description.

As the determination result of step S220, if the same reference audio signal as the input audio signal is present, the outgoing call may be maintained (S225). That is, since user voice is normally input, the mobile phone recognizes the call is a normal outgoing call. Here, a temporarily stored input audio signal may be deleted.

Conversely, if the same reference audio signal as the input audio signal is not present, since there is a possibility of an abnormal outgoing call, the mobile phone determines whether the outgoing call is a normal call. To this end, whether human voice is included in the input audio signal, whether strength of the voice is above a preset strength even when the human voice is included in the input audio signal, whether the voice includes a preset phrase even when the human voice is included in the input audio signal, and the like may be used, as described with reference to FIG. 1.

If it is determined that the outgoing call is an abnormal call as a result of determination in step S235, the mobile phone controls the outgoing call as in step S150 of FIG. 1.

However, if it is determined that the outgoing call is a normal call, the mobile phone generates or updates reference data by storing the input audio signal as new reference audio (S245) and maintains connection of the outgoing call (S250).

According to the present embodiment, an audio signal including actual voice of a user is prestored as reference data. Hence, it is easy to determine whether the outgoing call is a normal call by simple comparison of the audio signals. In other words, determination as to whether an outgoing call is a normal call can be performed by simple comparison of an input audio signal and a reference audio signal, without voice analysis processing according to whether voice is included in an input audio signal input through a microphone after the outgoing call is connected, whether strength of the voice is above a preset strength, or whether voice includes a preset phrase.

Hereinafter, the configuration of the mobile phone for performing the above-described outgoing call control method will be described.

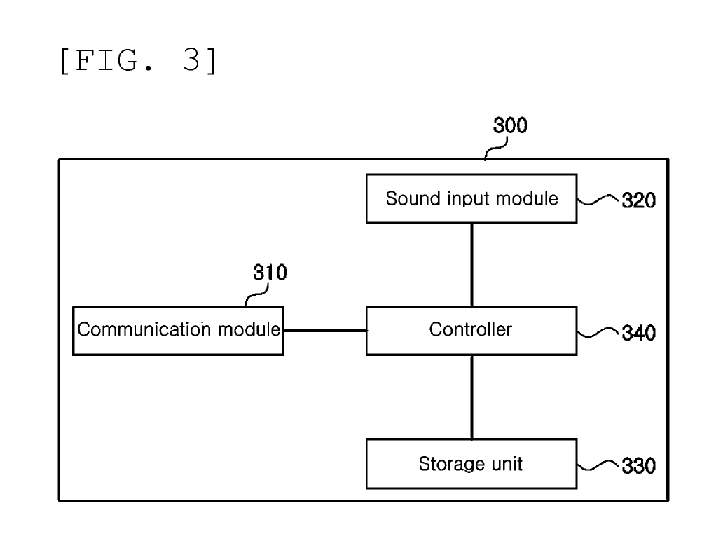

FIG. 3 is a view illustrating the configuration of a mobile phone for performing outgoing call control according to an embodiment of the present invention.

Referring to FIG. 3, a mobile phone 300 according to the present embodiment includes a communication module 310, a sound source input module 320, a storage unit 330, and a controller 340.

The communication module 310 is a communication means for a telephone call with other terminal devices through a communication network (e.g. a mobile communication network). The communication module 310 is well known to those skilled in the art and, therefore, a detailed description thereof will be omitted.

The sound source input module 320 serves to receive a sound source, such as voice, from the exterior and may be a microphone.

The storage unit 330 stores information for determining whether an outgoing call is a normal call. For example, data according to the above-described reference audio signal is stored in the storage unit 330.

The controller 340 performs a telephone call function by controlling the communication module 310. If an outgoing call is connected, the controller 340 analyzes a sound source input through the sound source input module 320 to determine whether the outgoing call is a normal call and processes a procedure according to the determination result. Since the determination as to whether the outgoing call is a normal call and the processing scheme according to the determination result have been described hereinabove, a detailed description thereof will be omitted.

The above-described outgoing call control method according to the present invention may be implemented as code that can be written on a computer-readable recording medium and thus read by a computer. The computer-readable recording medium may be all types of recording devices in which data decodable by a computer system is stored. The computer-readable recording medium may include, for example, a read-only memory (ROM), a random access memory (RAM), a magnetic tape, a flash memory, and an optical data storage device. The computer-readable recording medium can be distributed over computer systems connected by a computer communication network so that computer-readable code is written thereto and executed therefrom in a decentralized manner.

While the disclosure has been particularly shown and described with reference to exemplary embodiments, it will be understood by those of ordinary skill in the art that various changes in form and details may be made therein without departing from the spirit and scope of the disclosure as defined by the following claims.

What is claimed is:

1. A method for controlling an outgoing call in a mobile phone, comprising:
analyzing an input audio signal according to a preset reference upon a connection of the outgoing call, wherein the input audio signal is inputted from an external source through a microphone for a predetermined time; and
determining whether the outgoing call is a normal outgoing call or an abnormal outgoing call according to a result of the analyzing.

2. The method according to claim 1, wherein the analyzing includes determining whether at least one prestored reference audio signal includes an audio signal which is the same as the input audio signal.

3. The method according to claim 1, wherein the analyzing includes determining whether the input audio signal includes human voice having a preset strength.

4. The method according to claim 1, wherein the analyzing includes when the input audio signal includes human voice determining whether text obtained by analyzing the voice includes a preset phrase.

5. The method according to claim 1, further comprising when the outgoing call is determined to be the abnormal outgoing call releasing the connection of the outgoing call.

6. The method according to claim 5, further comprising transmitting a preset voice message to a called party before performing the releasing.

7. The method according to claim 5, further comprising transmitting a preset text message to a called party before or after performing the releasing.

8. The method according to claim 1, further comprising when the outgoing call is determined to be the abnormal outgoing call performing a vibration function or a preset sound output function.

9. A method for controlling an outgoing call in a mobile phone, comprising:
determining whether at least one prestored reference audio signal includes an audio signal which is the same as an input audio signal upon a connection of the outgoing call, wherein the input audio signal is inputted from an external source through a microphone for a predetermined time;
when the reference audio signal includes the audio signal processing the outgoing call as a normal outgoing call, and when the reference audio signal does not include the audio signal determining whether the outgoing call is the normal outgoing call or an abnormal outgoing call by analyzing the input audio signal; and
when the outgoing call is determined to be the normal outgoing call storing the input audio signal as a new reference audio signal, and when the outgoing call is determined to be the abnormal outgoing call controlling the outgoing call according to a predetermined scheme.

10. A recording medium readable by a digital information processing device, in which a program for performing the method of claim 1 is recorded.

11. A mobile communication device, comprising:
a communication module connecting a telephone call;
a sound input module receiving a sound from an external source; and
a controller configured to:
when a outgoing call is connected analyze an input audio signal according to a preset reference, wherein the input audio signal is inputted from an external source through the sound input module for a preset time, and
determining whether the outgoing call is a normal outgoing call or an abnormal outgoing call according to a result of the analyzing.

12. The mobile communication device according to claim 11, wherein the controller determines whether the outgoing call is the normal outgoing call or the abnormal outgoing call by determining whether the input audio signal includes human voice having a preset strength.
